(19) United States
(12) Patent Application Publication
(10) Pub. No.: US 2017/0172343 A1
(43) Pub. Date: Jun. 22, 2017

(54) OVEN SYSTEM FOR PRESSED FOOD ITEMS

(71) Applicant: TurboChef Technologies, Inc., Carrollton, TX (US)

(72) Inventors: James K. Pool, III, Frisco, TX (US); Pete Ashcraft, McKinney, TX (US); Karl Jobst, Corinth, TX (US)

(21) Appl. No.: 15/386,596

(22) Filed: Dec. 21, 2016

Related U.S. Application Data
(60) Provisional application No. 62/270,329, filed on Dec. 21, 2015.

(51) Int. Cl. A47J 37/06

(52) U.S. Cl. CPC A47J 37/0611; A47J 2037/0617

(57) ABSTRACT

Embodiments of the invention described herein thus provide systems and methods for creating a pressed food item in an oven cooking cavity. The oven system is secured within the oven cooking cavity and is not dependent upon oven door movement or any other oven function. An upper platen is configured to move up and down with respect to a lower platen in order to press a food item during the cooking process. The lower platen is generally secured with respect to the oven interior, whether to a jet plate, to an oven wall, or to a frame that is secured within the oven. The upper platen moves along a vertical support system. When the oven system is not in use to create a pressed food item, the upper platen can remain in a lowered position so that the oven may be used without the pressing features described.

### CROSS REFERENCE TO RELATED APPLICATIONS

This application claims the benefit of U.S. Provisional Application Ser. No. 62/270,329, filed Dec. 21, 2015, titled “Panini Press Oven,” the entire contents of which are hereby incorporated by reference.

### FIELD OF THE DISCLOSURE

Embodiments of the present disclosure relate generally to an oven system for pressed food items. The oven system is secured within an oven cooking cavity. An upper platen is configured to move up and down with respect to a lower platen in order to press a food item during the cooking process. It is also possible for the upper platen to remain in a lowered position so that the oven may be used without the pressing features described.

### BACKGROUND

Panini sandwiches and other pressed food items are well known in today's marketplace. A Panini sandwich, Cuban sandwich, quesadilla, or other pressed sandwich or food item (generally referred to herein as a “pressed food item”) is heated and pressed between two platens in order to compress the food item and to create grill marks. The traditional method for preparing a Panini sandwich is to place the sandwich in a Panini press machine. The machine typically consists of two hinged, ribbed, and heated platens. A sandwich is placed between the two platens and the platens are closed with respect to one another. The weight of the upper platen begins to press the food as it heats. A user may even choose to press down on the upper platen in order to compress the sandwich further. A typical sandwich may be positioned into the press machine having a sandwich height of between about 1.5 to 3 inches and will be compressed approximately 25-50%, depending upon the weight of the upper platen and the type of bread used.

Panini sandwiches and other pressed food items are an up-scale sandwich/food item that command a higher price than traditional toasted or grilled sandwiches. Given their popularity, there are many manufacturers of Panini press machines. The available machines, however, have similar problems. For example, they require several minutes to heat the sandwich. They require a thermal recovery. They do not heat the internal (center) of the sandwich consistently or adequately. In many jurisdictions, they require type 1 ventilation. They are purpose-built units and can do little more than press sandwiches. They may give off unpleasant odors. Cheese or other melt-able ingredients may ooze out sides or backs of the machines. The machines are also not long-lasting; primary customer complaints include that the platen coatings and hinge mechanisms fail. Accordingly, improvements to pressed sandwich/food item preparation are necessary.

### BRIEF SUMMARY

Embodiments of the invention described herein thus provide systems and methods for creating a pressed food item in an oven cooking cavity. The oven system is secured within the oven cooking cavity and is not dependent upon oven door movement or any other oven function. An upper platen is configured to move up and down with respect to a lower platen in order to press a food item during the cooking process. The lower platen is generally secured with respect to the oven interior, whether to a jet plate, to an oven wall, or to a frame that is secured within the oven. The upper platen moves along a vertical support system. When the oven system is not in use to create a pressed food item, the upper platen can remain in a lowered position so that the oven may be used without the pressing features described.

### BRIEF DESCRIPTION OF THE DRAWINGS

FIG. 1 shows a side perspective view of one example of an oven system frame.

FIG. 2 shows the oven system frame of FIG. 1 with a lower platen in the process of being positioned.

FIG. 3 shows an oven system frame with an upper platen in the open position and a lower platen in a stable secured position.

FIG. 4 shows a side plan view of an oven cooking cavity with an oven system for pressed food items positioned therein.

FIG. 5 shows a side perspective view of the oven system of FIG. 3, with a detachable handle secured to the upper platen.

FIG. 6 shows a side perspective view of the oven system of FIG. 3, with the upper platen moved to the closed position.

FIG. 7 shows a side perspective view of the oven system of FIG. 3, with the detachable handle removed from the system.

FIG. 8 shows an exploded view of one example of a detachable handle.

FIG. 9 shows a side perspective view of an alternate embodiment of a vertical support system that uses vertical tracks.

FIG. 10 shows a perspective view of an upper platen for use with the vertical tracks shown in FIG. 9.

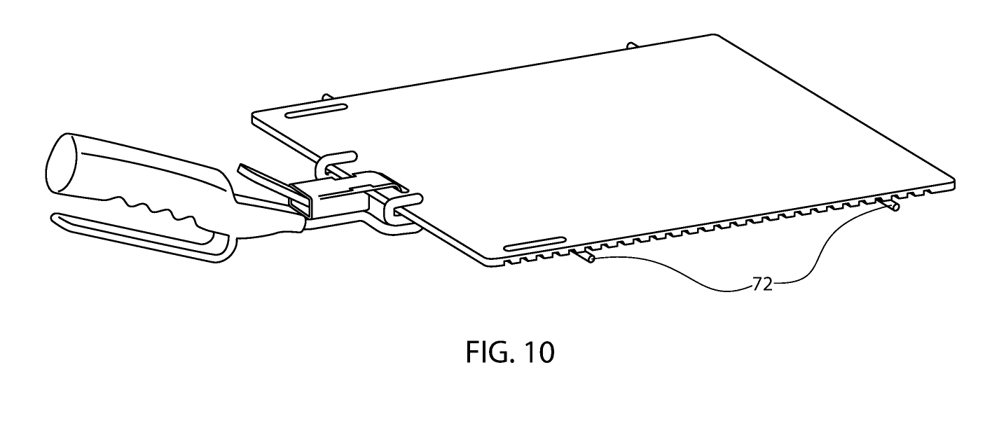

FIG. 11 shows a side perspective view of an alternate embodiment of a door-activated pressing system.

### DETAILED DESCRIPTION

Embodiments of the present invention provide an oven system for pressed food items. The system described herein may be used in connection with conventional ovens, convection ovens, toaster ovens, commercial ovens, residential ovens, or any other type of cooking device that has a cooking cavity. The oven system for pressed food items allows the pressing function of the platens to take place within a cooking cavity.

Referring now to the figures, the oven system 10 for pressed food items includes a lower platen 12, an upper platen 14, and a vertical support system 20. The lower platen 12 remains generally stationary in use, and the upper platen 14 is caused to move with respect thereto. The lower platen 12 is generally positioned parallel with respect to a lower surface or jet plate of the oven. The upper platen 14 is supported by the vertical support system 20 and moves therealong in order to be positioned between an open position, a closed position and a cooking position. In its open position, the upper platen 14 is generally parallel to the lower platen 12 so that the two platens 12, 14 define an open space between all edges of the platens (including the front edges as well as the back edges). They are not hinged together.

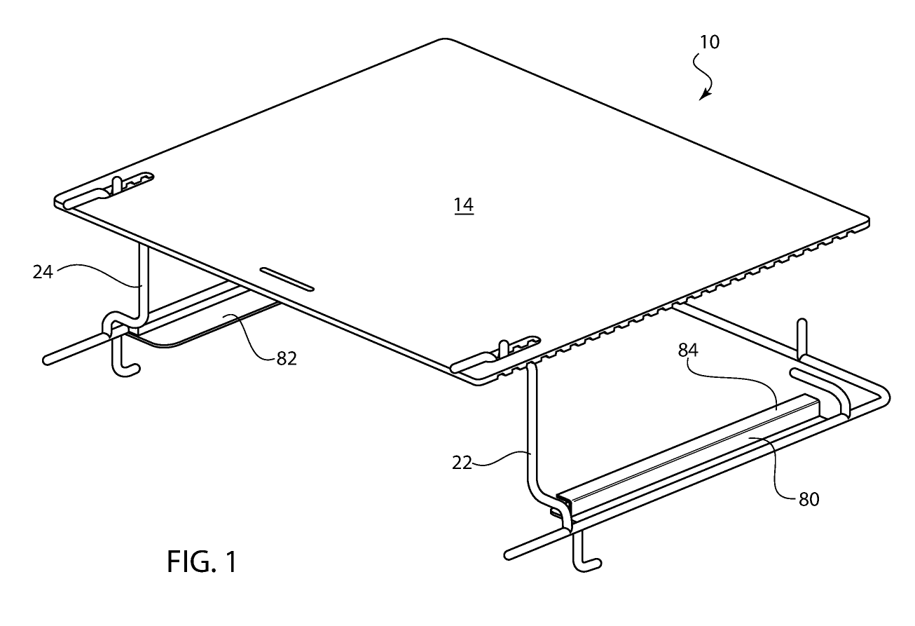

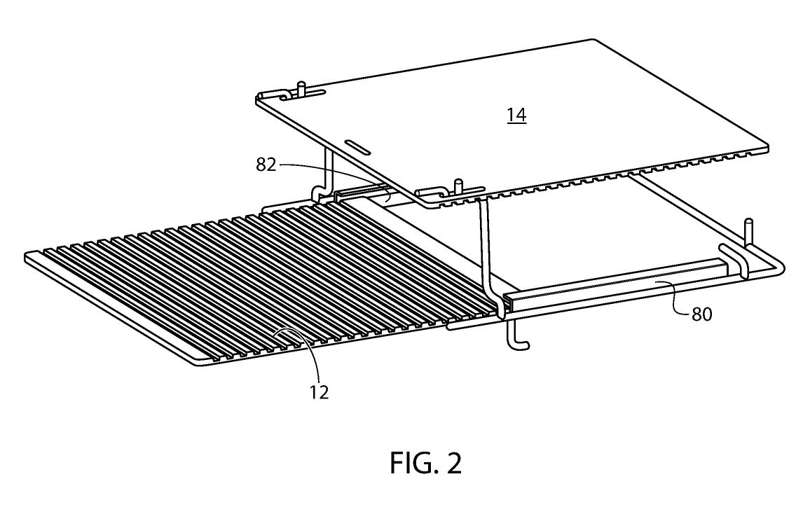

A standard oven can have the system 10 easily installed. In one example, the base structure of the system may be a wire rack or frame 80 that connects to the oven cavity. The frame 80 includes two vertical supports 22, 24. In one example, the frame 80 is formed as a wire rack with an inward facing lip 82 that can help support the lower platen 12 in use. FIG. 1 illustrates a frame 80 with an upper platen 14 in place and without a lower platen. FIG. 2 illustrates a lower platen 12 being positioned with respect to the frame 80. The lower platen 12 may rest on the inward facing lip 82 of the frame 80. The frame 80 may function like a drawer base, supporting the lower platen 12 as it slides in and out with respect to the frame 80. A side securement lip 84 may also be positioned on the frame 80. This side lip 84 can help prevent upward movement of the lower platen 12 once positioned.

The lower platen 12 is generally intended to remain stationary in use. The upper platen 14 is designed to be movable (i.e., raised and lowered) with respect to the lower platen 12, as described further below. The upper platen 14 may move along the vertical support system 20. In the examples shown, the vertical support system 20 is provided as first and second vertical supports 22, 24. One or both of the platens 12, 14 have vertical support system cooperating openings 26, 28 along plate edges 30. These openings 26, 28 are sized and shaped to receive vertical supports 22, 24 and to slide vertically as well as horizontally with respect thereto.

In one example, each of the lower and upper platens has a ribbed surface 32 and a flat surface 34. It is generally envisioned that the ribbed surface 32 be positioned on one side of the platen and that the flat surface 34 be positioned on the opposite side of the platen. However, it is also possible for a single surface of the platen to have both a ribbed surface and a flat surface on the same side. The ribbed surface 32 is designed to provide grill marks on the food item due to heat and compression. The flat surface 34 can still heat and compress the food item, but it does not provide grill marks due to the flat nature of the surface that remains in contact with the food item. In other examples, both the top and bottom surfaces of one or more of the platens may both be ribbed or both the top and bottom surfaces of one or more platens may both be flat. Any combination of these options is also envisioned. In the example illustrated by FIGS. 2-7, the ribbed surface 32 of the upper platen 14 is facing down and the ribbed the surface 32 of the lower platen 12 is facing up. This allows grill marks to be positioned on both sides of the food item compressed therebetween.

The platens 12, 14 may be removed from the vertical support system 20 in order to switch between the ribbed surface 32 or the flat surface 34. The platens 12, 14 may be also removed from the oven for cleaning. In one example, the platens 12, 14 and the frame 80/vertical support system 20 may be assembled outside the oven and inserted as a complete rack system 10. Alternatively, the frame 80 may be positioned in the oven and then the platens 12, 14 positioned with respect thereto.

A specific embodiment of the oven rack system 10 for pressed food items described herein is intended for use with a rapid cook oven, such as the type manufactured and sold by TurboChef Technologies, Inc. of Carrollton, Tex. Such ovens are generally intended for use in commercial food preparation and serving establishments. The oven rack system 10 finds particular use in connection with ovens that deliver forced hot air in combination with a microwave system, which can lead to a fast cooking process. However, it is also possible for the oven rack system 10 for pressed food items described herein to be used in connection with residential ovens or toaster ovens. In these instances, the securement of the rack with respect to the cooking cavity may be accomplished via the systems described herein or by any other appropriate securement systems appropriate for the oven in which the rack is used.

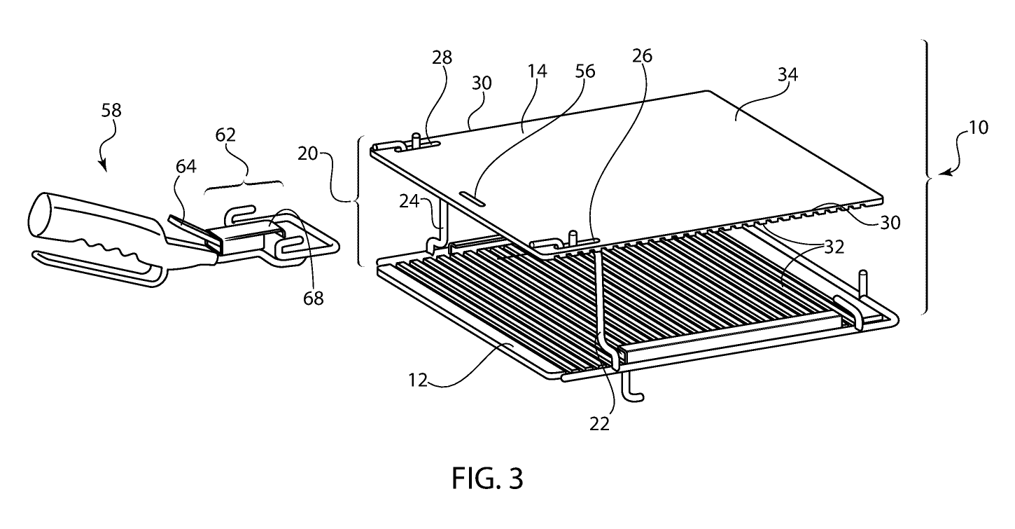

FIG. 3 illustrates the complete rack system 10 as it would be positioned within an oven. The upper platen 14 is shown in an open position. In this position, the first and second vertical supports 22, 24 extend through the openings 26, 28 of the upper platen 14. The openings 26, 28 of the upper platen 14 are positioned over the vertical supports 22, 24 so that upper portions of the supports fit inside the openings.

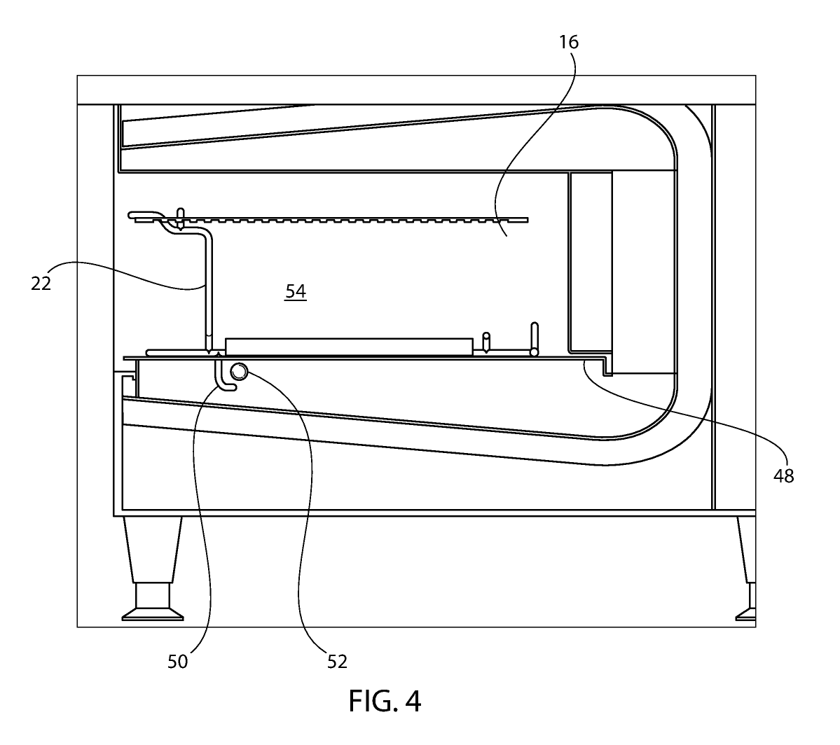

FIG. 4 illustrates one way in which the rack system 10 may be positioned within an oven cooking cavity 16. It should be understood, however, that securement of the rack system 10 into to the cooking cavity 16 may occur in various ways, some alternate versions of which are outlined at the end of this document. In the example illustrated, the frame 80 is stably secured with respect to the cooking cavity 16. The frame 80 is positioned with respect to a lower jet plate 48. The frame 80 has a lower connection feature 50. In the figures, the lower connection feature 50 is illustrated as a curved hook. The lower connection feature 50 can extend through a slot in the lower jet plate 48. The lower connection feature 50 can engage a stud 52 along an inner cavity wall 54. Although it is possible for only one of the securement options to be used, a combination of both can help confirm a secure positioning. Engagement of the lower connection feature 50 with the stud 52 locks the frame 80 into place. The frame 80 may be pushed forward in order to engage the lower connection feature 50 with the stud 52. Once the connection feature 50 has engaged the stud 52, the rack frame cannot move vertically. This securement also locks the jet plate 48 in place. The upper platen 14 is free to move along the vertical supports. In order to remove the rack frame from the oven, the frame can be slid forward and tilted so that the connection feature 50 slides away from and disengages the stud 52.

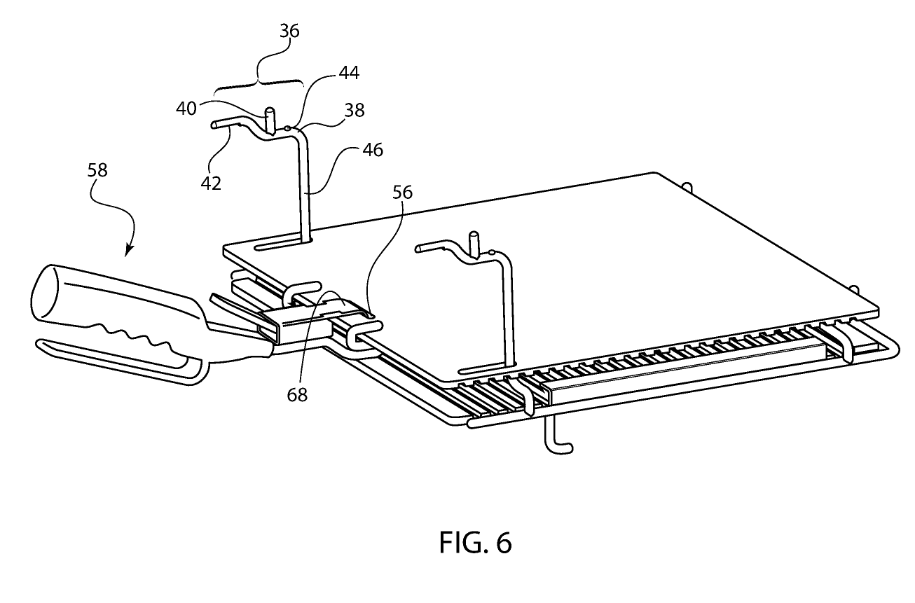

When the upper platen 14 is in the open position, the upper platen 14 is allowed to rest on a platform support 36 of each vertical support. For ease of discussion, a single vertical support 22 and platform support 36 is described, although it should be understood that both vertical supports have the same features. FIGS. 3-5 illustrate the platform support 36 with the upper platen 14 supported thereby. FIG. 6 illustrates the upper platen 14 once moved away from the platform supports 36 (and shows features of the platform supports more clearly).

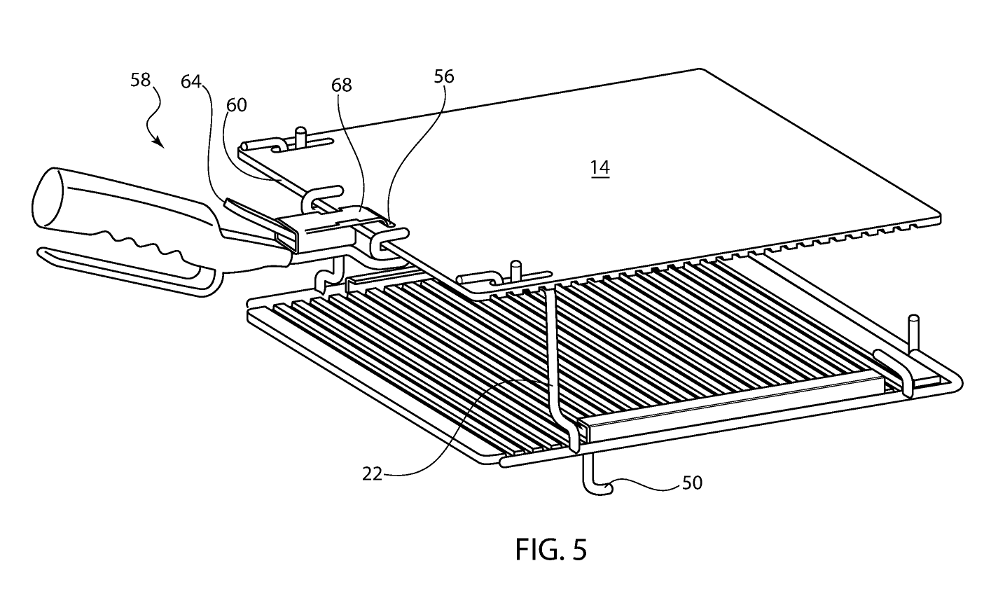

Each platform support 36 provides a surface on which the upper platen may rest and be supported. In a specific example, a platform support 36 may have a first horizontal element 38. The first horizontal element 38 is illustrated as having a stop post 40. In use, the stop post 40 prevents the upper platen 14 from moving too far forward or too far back with respect to the vertical support 22. The stop post 40 abuts an edge of one of the platen openings 26, 28. The first horizontal element 38 is also illustrated as having a detent system. In a specific embodiment, the detent system may be formed via cooperation between a nub 44 and a similarly-shaped indentation (not shown) in a lower surface of the upper platen 14. Because the platens may be reversible, an indentation may be provided along a similar location on both a top surface and a bottom surface of the upper platen 14. (Although it should be understood that the nub and detent locations may be reversed.) The platform support 36 is also shown as having a second horizontal element 42. This second horizontal element 42 may extend up through openings 26, 28 in use, as illustrated by FIG. 5.

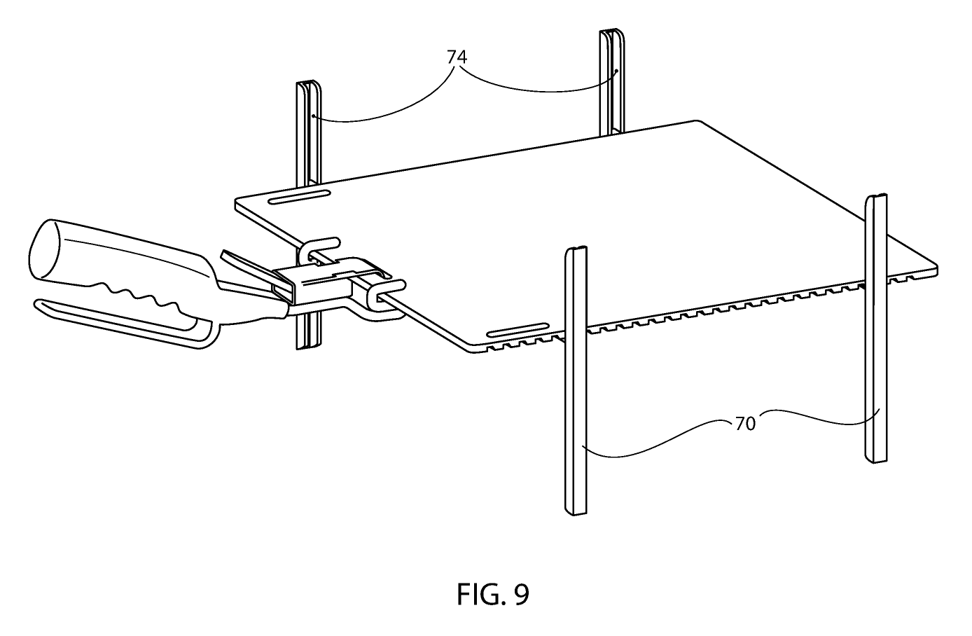

In an alternate example, the vertical support system may be a vertical track 70, as illustrated by FIG. 9. In this example, one or more vertical tracks 70 may be installed along sidewalls of the cooking cavity. In the example shown, there are four vertical tracks 70 in use. It is possible, however, to provide a single pair of vertical tracks, one along each side wall of the oven cooking cavity. Additional further tracks 70 may be used as well. The vertical tracks 70 are generally provided with an inner channel 74 that is sized and configured to receive a side peg 72 of the upper platen. The inner channel 74 may be notched, such that the side peg 72 may be stopped along any desired height. In another example, only the upper portion of the inner channel 74 is notched in order to receive and secure the side peg 72 in place so that the upper platen may be stopped and secured in its open position.

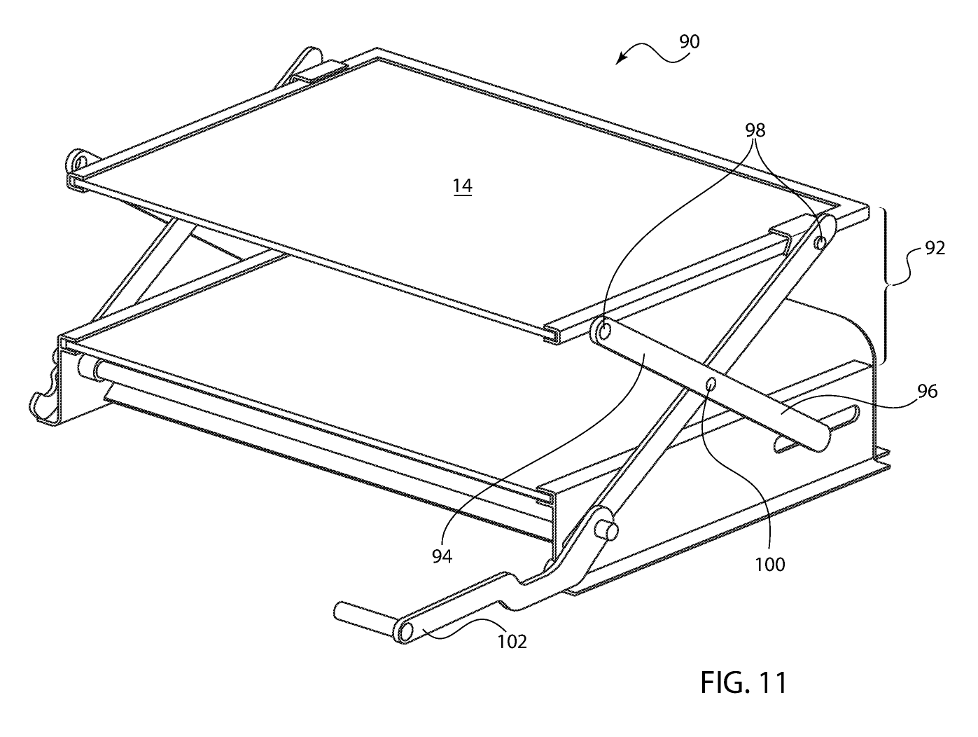

In a further alternate example, it is possible for the upper platen to move via operation of the oven door. In this version, opening and closing of the oven door causes raising and lowering of the upper platen. One example of such a door-activated pressing system 90 is illustrated by FIG. 11. This system 90 includes a scissor mechanism 92 that functions to raise and lower the upper platen 14. First scissor arm 94 is secured to an upper front portion of the upper platen 14 and a lower rear portion of the lower platen 12. Second scissor arm 96 is secured to an upper rear portion of the upper platen 14 and a lower front portion of the lower platen 12. Securement may be via pivot points 98. Central pivot 100 allows the scissor arms 94, 96 to raise and lower upon movement of activating arm 102. As illustrated, activating arm 102 is secured to at least one of the pivot points such that movement of the arm 102 causes movement of the scissor mechanism 92. Activating arm 102 may be secured to a lower pivot point or an upper pivot point. The activating arm connecting pivot point may be positioned directly on or along one of the platens. In another example, the activating arm connecting pivot point may be positioned on a base frame that supports one of the platens. The activating arm 102 is also secured to the oven door. Thus, when a user opens or closes the oven door, the activating arm 102 is forced to raise or lower, which in turn causes activation of the scissor mechanism 92 to either raise or lower the upper platen 14.

In another example, the vertical support system (whether the vertical support rods or the vertical track embodiments) may be associated with the oven door, such that the upper platen is raised and lowered automatically by opening and closing of the oven door. For example, an arm may be secured to the upper platen that is also secured to the oven door, such that movement of the upper platen is caused by opening or closing of the oven door.

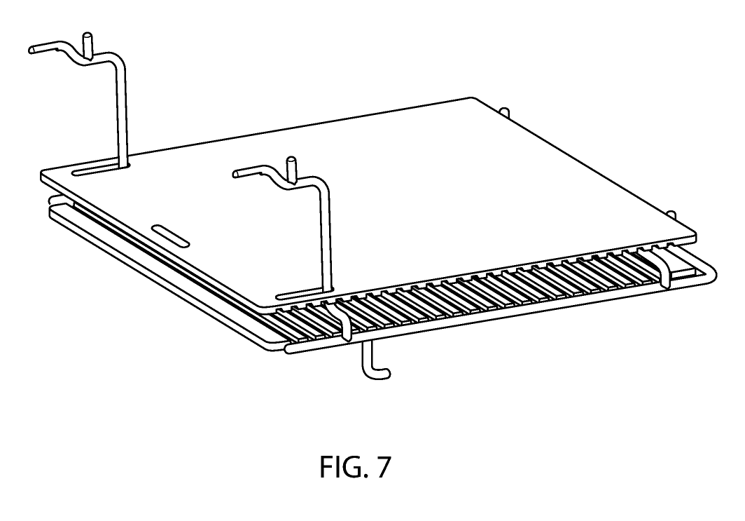

When the platens are in an open position, there is a space formed therebetween. When the system is intended to be used to create a pressed food item, the upper platen 14 is lowered. The lowered position of the upper platen 14 is illustrated by FIGS. 6 and 7 (without a sandwich or other food item positioned between the platens).

It is possible to raise and lower the upper platen 14 by hand, without a separate handle. However, once the oven system 10 has been used to heat and press a food item, the platens are likely too hot for manual handling. A user may wear an oven mitt in order to cause movement of the upper platen 14. However, this option may not be desirable in certain instances. Accordingly, in one embodiment, the upper platen 14 has a handle securement interface 56 that cooperates with a detachable handle 58. The handle securement interface 56 may be an opening along or close to an edge 60 of the platen that faces the oven door.

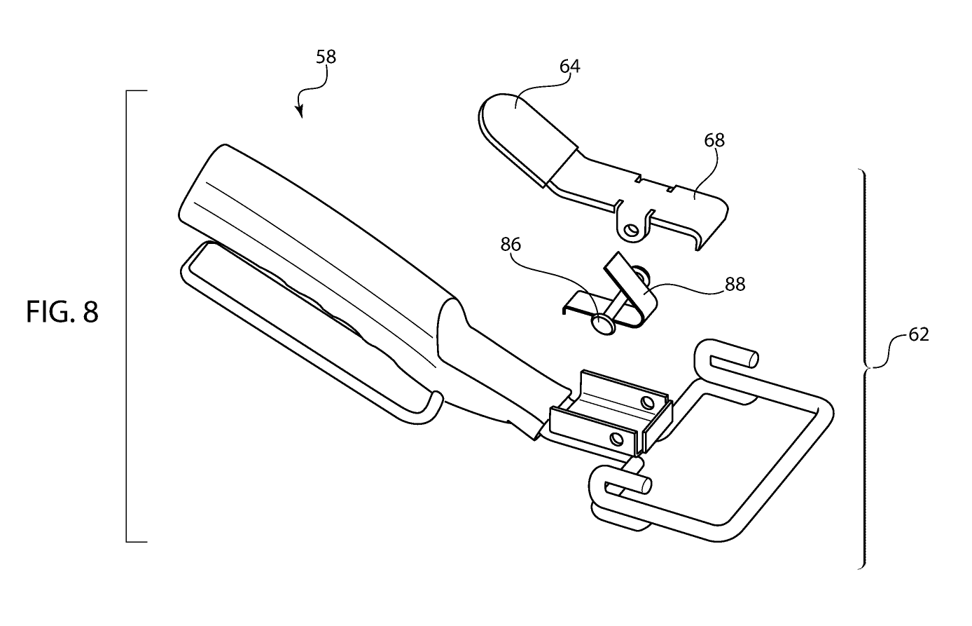

One example of a handle 58 is illustrated by FIG. 8. The detachable handle 58 may have openable jaws 62 that are operable via a hinge. Depression of a lever portion 64 may cause the jaws 62 to open. A clamp 68 of the jaws may then engage the handle securement interface 56. (Although the clamp 68 is illustrated as an upper clamp, it should be understood that the clamp 68 may be a lower clamp instead or as well.) Release of the lever portion 64 causes the jaws to close and secure the upper platen 14 with respect to the handle 58. The handle may have a locking pivot feature 86. Pressure on the lever portion 64 opens the jaws 62 and causes engagement of one of the clamp 68 with the plate opening 56. Release of pressure on the lever portion 64 allows a pivoting spring 88 to force the clamp 68 into the closed position. Once engaged, the handle 58 and the upper platen 14 are securely attached. Movement of the handle 58 then causes movement of the upper platen 14. Although one specific example of a handle is described herein, it should be understood that alternate options are possible and considered within the scope of this disclosure.

FIG. 5 illustrates a handle 58 being secured to the upper platen 14. FIG. 6 illustrates the upper platen 14 in its lowered/closed position, with a handle still secured thereto. In order to move between the position of FIG. 5 and the position of FIG. 6 (i.e., once the food product is loaded between the platens), the upper platen 14 is lifted by the operator by (in some instances, by engaging the handle 58) and sliding the openings 26, 28 away from the second horizontal element 42 of the platform support 36. The operator then tilts the upper platen slightly upward and forward over the stop post 40. Once the openings 26, 28 of the upper platen 14 are released from the platform support, the platen 14 may slide down the elongated portion 46 of each vertical support, lowering the upper platen 14 down onto the food product. Once the upper platen 14 is resting on the food product, the operator dis-engages the detachable handle by pressing the thumb lever 64, which opens the clamp 68. The system disclosed is designed to use gravity. The weight of the upper platen during the cook cycle is used to press and compress a sandwich or other food product.

When a sandwich or other food item is placed between the platens 12, 14 and the upper platen 14 is lowered on top of the sandwich by the operator, the two grill plates emulate a traditional Panini press. Because the sandwich is inside of a rapid cook oven or other oven environment, various heat-transfer technologies can be used to thoroughly heat the sandwich. A typical Panini sandwich requires 3-5 minutes in a press. If the oven system described herein is used in a TurboChef rapid cook oven, employment of microwave and high velocity impingement air can heat the sandwich or other food item in 45 seconds to 90 seconds and still provide the visual attributes of a Panini sandwich (pressed and grilled). The center of the sandwich or pressed food item is also fully heated. Because the press is positioned inside an oven, it is also possible to take advantage of the oven's catalytic filtration that destroys and grease, smoke, and/or off odors that can develop during the cooking process, obviating the need for a type 1 hood.

When the cook cycle is completed, the operator opens the oven door and re-engages the detachable handle 58 into the front slot 56 of the upper platen 14 by pressing the thumb lever 64 and engaging the clamp 68 with the opening 56 of the upper platen 14. The operator then moves the upper platen from its closed position to its open position. To move the upper platen 14 back to the open position, the upper platen is lifted vertically to the horizontal resting section (platform support 36) at the top of the vertical supports 22, 24. When the upper platen 14 reaches the top, the platen is pulled backwards and tilted slightly upwards so that the side openings 26, 28 fit over the post 40 on the platform support 36 of the vertical supports and can lock into the open position.

The finished food product is then removed from the oven. At this point, the operator can load another food product into the food press system 10 and repeat as described above to make another product, or lower the upper platen 14 from the open position to the closed position to cook a non-pressed product or simply close the oven door for the oven to remain in ready mode until the next pressed or non-pressed food item is to be cooked.

FIG. 7 illustrates the system positioned in the oven, with the upper platen 14 in a closed position. In this position, the upper platen 14 has been disengaged from the platform support 36 and is allowed to slide down the vertical supports 22, 24. If a food item to be pressed is present, the upper platen 14 contacts the food item (rather than the lower platen 12 as shown).

Some benefits of the oven system 10 described are that it is semi-automatic; there is not a complicated mechanical mechanism to fail. The plates are positioned within the oven cavity; they are not related to or operated with opening and closing of the oven door. The platens are easily replaceable. For example if the non-stick coating becomes worn or chipped or if the platens need to be periodically cleaned, they may interchanged with new ones. The system does not require thermal recovery because the platens are contained in a controlled heated environment. The system also allows for normal/non-pressed food item cooking without removing any internal structure or components. Providing the option of smooth and ribbed platens allows the operator to configure the oven for pressed, but non-grilled marked food items. The detachable/locking handle 58 easily engages and dis-engages from the upper platen, thus providing a safe and positive way to move the platen.

The platens can remain inside the oven cavity 16 and need only be activated when a panini-press type food product is desired. The remainder of the time, the upper platen 14 may remain in the closed position. In other words, when a pressed food item is not required, the upper platen 14 can be lowered and allowed to sit directly above the lower platen 12. If the top-side of the upper platen 14 is not ribbed or otherwise a flat surface, regular (non-panini) items may be cooked inside the oven. While the system is in the closed position, the oven can be used for all rapid cook cooking/heating applications as if there were no food pressing system 10 in the oven because the height of the upper plate is the same as the current base of the oven, and the vertical supports on the sides of the oven cavity do not obstruct loading and unloading of products in and out of the oven cavity. It is also possible to remove the upper platen 14 entirely. It is further possible to remove the entire frame completely. The oven system 10 described thus converts an oven from a standard rapid cook oven to a “panini oven” and then back to a standard rapid cook oven (whether with or without the system remaining in place in the oven), making it a convertible and semi-automated appliance.

The material of the platens is desirably conductive and has a high specific heat. In a specific example, the platens may be aluminum plates. It is possible for the platens to be made of any material currently used in panini press machines or any future materials that may be developed.

In alternate platen designs, the vertical supports 22, 24 of the vertical support system 20 may be integrally formed with the lower platen 12. For example, a lower portion of the vertical supports may be welded to the lower platen. In another example, the vertical support system 20 may cooperate with both the lower platen 12 and the upper platen 14. Both platens 12, 14 may have side openings 26, 28 for cooperating with the vertical supports 22, 24. In this way, both the lower and upper platens 12, 14 are allowed to move with respect to the support system 20. It should also be understood that more than two vertical supports may be used in system described (e.g., two front support rods and two rear support rods).

In a further example, the lower platen 12 may be secured directly to a lower rack or other structure of the cooking cavity 16. The lower platen 12 itself may have one or more side cooks or clips that allow it to be secured to a lower rack, such as a jet plate. The vertical supports 22, 24 need not cooperate with the lower platen 12 in this embodiment. They may be separately installed in the oven cavity. They may be positioned with respect to a frame 80 that does not support the lower platen 12. The lower platen may have a larger or small area than the upper platen 14.

Changes and modifications, additions and deletions may be made to the structures and methods recited above and shown in the drawings without departing from the scope or spirit of the disclosure or the following claims.

What is claimed is:

1. An oven system for pressed food items, comprising:
a lower platen configured to be positioned within an oven cooking cavity;
an upper platen configured to move with respect to the lower platen,
a vertical support system configured to allow the upper platen to be raised and lowered with respect to the lower platen and to secure the upper platen into an open position.

2. The oven system of claim 1, wherein the vertical support system comprises vertical supports and wherein the upper platen comprises one or more openings for cooperating with and along the vertical supports.

3. The oven system of claim 1, wherein the vertical support system comprises a vertical track along sides of the cooking cavity, and wherein the upper platen comprises side pegs for cooperating with and along the vertical track.

4. The oven system of claim 1, further comprising a frame supporting the vertical support system.

5. The oven system of claim 4, wherein the frame comprises a lower connection feature that extends through an oven jet plate.

6. The oven system of claim 4, wherein the frame comprises a lower connection feature that locks with respect to a stud on an inner wall of the cooking cavity.

7. The oven system of claim 4, wherein the vertical support system comprises first and second vertical supports, the first vertical support positioned along a first side edge of the frame and the second vertical support positioned along a second side edge of the frame.

8. The oven system of claim 4, wherein the frame comprises an inward lip and a side lip for supporting the lower platen in use.

9. The oven system of claim 1, wherein the vertical support system comprises first and second vertical supports.

10. The oven system of claim 1, the upper platen further comprising a handle securement interface.

11. The oven system of claim 10, further comprising a handle for securing the handle securement interface for movement of the upper platen with respect to the lower platen.

12. The oven system of claim 10 wherein the handle securement interface is positioned on an oven front-facing surface of the upper platen.

13. The oven system of claim 1, further comprising a detachable handle configured to secure with respect to the upper platen, the detachable handle comprising a lever portion and openable jaws for securing with respect to the upper platen.

14. The oven system of claim 1, wherein the lower platen and upper platen each have a first ribbed surface and a second flat surface.

15. The oven system of claim 1, wherein the vertical support system comprises first and second vertical supports, each having a platform support.

16. The oven system of claim 15, wherein the platform support comprises a stop post.

17. The oven system of claim 15, wherein the platform support comprises a detent system.

18. The oven system of claim 17, wherein the detent system comprises a nub on the platform support and an indentation on a contacting surface on the upper platen that receives the nub in use.

19. The oven system of claim 17, wherein the detent system comprises an nub on the upper platen and an indentation on the platform support that receives the nub in use.

20. The oven system of claim 1, wherein the upper platen is raised and lowered via opening and closing of an oven door.

21. The oven system of claim 1, wherein the cooking cavity comprises delivery of forced hot air and a microwave system.

22. A door-activated oven system for pressed food items, comprising:
a lower platen configured to be positioned within an oven cooking cavity;
an upper platen configured to move with respect to the lower platen,
a scissor mechanism cooperating with both the lower platen and the upper platen, the scissor mechanism comprising an activating arm configured to be secured to an oven door, wherein opening and closing of the oven door causes raising and lowering of the upper platen.

23. A method for pressing a food item in an oven, comprising:
providing a food item pressing system comprising upper and lower platens that are movable along a frame and vertical support system with respect to one another, the frame configured to be secured within the oven,
moving the upper platen to an open position;
positioning a food item to be pressed on the lower platen;
lowering the upper platen to a closed position such that it contact the food item to be pressed.

24. The method of claim 23, further comprising providing a detachable handle, and attaching the detachable handle to the upper platen in order to move the upper platen between its open or closed position.
